(19) United States
(12) Patent Application Publication
(10) Pub. No.: US 2004/0030648 A1
(43) Pub. Date: Feb. 12, 2004

(54) Methods of doing the business of machine vending

(76) Inventor: Munroe Chirnomas, Morris Township, NJ (US)

Correspondence Address: AUTOMATIC IMPULSE MACHINE DESIGN INC, LAWRENCE C EDELMAN, IP COUNSEL, 1 CORY RD, MORRIS TOWNSHIP, NJ, 07960, US

(21) Appl. No.: 10/215,093

(22) Filed: Aug. 8, 2002

(51) Int. Cl. G06F 17/60

(52) U.S. Cl. 705/43

(57) ABSTRACT

Methods of doing the business of machine vending with a third party are disclosed. The third party issues an authorization code that prevents a computerized vending machine (“CVM”) from being shut down automatically, or a de-authorization code that causes the CVM to be at least partially shut down. Use of such codes makes it more prudent for parties to enter into contracts that were previously impractical or susceptible of abuse by dishonest vending machine operators.

### CROSS-REFERENCE TO RELATED APPLICATIONS

This patent application claims priority under 35 USC 120 of PCT/US01/16893, filed May 23, 2001, entitled METHODS OF DOING THE BUSINESS OF MACHINE VENDING, which itself claims priority under 35 USC 119 and 35 USC 120 of U.S. Provisional Patent Application No. 60/206,363, filed May 23, 2000, entitled METHOD AND APPARATUS FOR ARTICLE HANDLING, SUCH AS FOR A VENDING MACHINE, and U.S. Provisional Patent Application No. 60/257,316, filed Dec. 21, 2000 and entitled METHOD AND APPARATUS FOR ARTICLE HANDLING, SUCH AS FOR A VENDING MACHINE;. The entire disclosure of these applications, including the drawings, are hereby incorporated into this application as if fully set forth herein. Additionally, the entire disclosures (including drawings) of the following PCT patent applications, all filed on May 23, 2001 and all naming Munroe Chimomas as inventor, are likewise incorporated herein as if fully set forth:

1) PCT/US01/16916, filed May 23, 2001, entitled METHOD AND APPARATUS FOR ARTICLE CONTACT DETECTION IN AN ARTICLE HANDLING DEVICE;

2) PCT/US01/16847, filed May 23, 2001, entitled METHOD AND APPARATUS FOR STORING ARTICLES FOR USE WITH AN ARTICLE HANDLING DEVICE;

3) PCT/US01/16846, filed May 23, 2001, entitled METHOD AND APPARATUS FOR HOSE STORAGE IN AN ARTICLE HANDLING DEVICE;

4) PCT/US01/16894, filed May 23, 2001, entitled METHOD AND APPARATUS FOR POSITIONING AN ARTICLE HANDLING DEVICE; and

5) PCT/US01/16853, filed May 23, 2001, entitled METHOD AND APPARATUS FOR INCLUDING ARTICLE IDENTIFICATION IN AN ARTICLE HANDLING DEVICE.

### BACKGROUND OF THE INVENTION

The invention relates to methods of doing business, and more particularly relates to methods of doing the business of machine vending. In its most immediate sense, the invention relates to methods of doing machine vending using a computerized vending machine, or CVM, such as is disclosed in the above-referenced patent applications.

Existing methods of doing business using vending machines, and indeed existing contractual relationships that relate to such machines, are based upon a conventional vending machine of the self-standing type.

In such methods and relationships, an “operator” of the machine (this may be an owner or lessee of the machine) sites the machine at a particular location controlled by a person having an interest in the real property at that location (the “landlord”). (For the purposes of this invention, the landlord may own the property, may be a lessee, or a real estate agent. And, the landlord need not be different from the “operator”.) The operator contracts with a seller of goods (e.g. the “manufacturer” of snack foods, which usually is but need not necessarily be different from the operator or the landlord) that are loaded into the machine. When a purchaser purchases goods from the machine, he or she makes a payment to the machine and gets the goods in return. The operator periodically collects the money and pays the landlord and the manufacturer. If the owner is a lessee or has purchased the machine with financing provided by a lender, then the owner will also pay the lender (e.g. a bank) from the money collected from the machine.

Heretofore, the contractual relationships between these parties have been independent of the actual operations carried out by the machine. For example, the landlord will charge the operator rent based e.g. upon the location and size of the place where the machine is located and the cost of providing electricity to operate the machine. So, too, the lender will charge the operator a sum that is related to the amount loaned to the operator and to whatever interest rate currently applies. Likewise, the manufacturer will charge the operator a price related to the quantity and nature of the goods the operator elects to purchase.

Such relatively simple contracts are different from those used in analogous retail situations. For example, a store in a shopping center will conventionally pay the landlord a negotiated percentage of its sales. Such a pay-as-you-go arrangement can be highly beneficial for both parties, since they can share the risks and rewards of the business and can adjust the share to correspond to e.g. the financial status of the tenant.

Such arrangements have not been practical for vending machines. This is because such machines must be physically visited by persons who e.g. remove cash from them, and such persons cannot easily be supervised by third parties such as banks or landlords. Furthermore, operators can and do change the product offerings of the machines to better match the wants of the persons who purchase items from them, and it would be very difficult for e.g. a bank or a landlord to know exactly what goods were loaded into a particular machine at any particular time.

Operators, landlords, manufacturers, and lenders would all benefit from contractual relationships wherein payments related to vending machines would depend upon actual operations carried out by the machine, i.e. would depend upon e.g. the number, types, and prices of items sold from the machine, the time of day that the machine was most often used, sales data collected by the machine, etc.

Accordingly, an object of the invention is to provide a method of doing business wherein persons could receive payments based on actual operations carried out a vending machine.

Another object of the invention is to provide a method of doing business wherein a person who is in physical possession of such a machine may be deprived of some or all of the economic benefits of the machine without the need to physically take the machine away from the person in possession of it.

The invention proceeds from the realization that a CVM can be provided with computer intelligence sufficient to wholly or partly reversibly disable operation of the CVM, or to re-enable operation of the CVM again, by timely inputting an authorization code or a deauthorization code, and that the use of such a code will engender confidence in a third party that he or she will be properly paid. For example, let it be assumed that a bank finances the operator's purchase of a CVM and the operator pays the bank every 30 days. The CVM will be programmed to automatically shut down at 30 day intervals. If the operator actually pays the bank, then the bank will provide the operator with an authorization code that the operator can input to the CVM to keep the machine operating after the 30 days has passed. If the operator does not pay the bank, then the CVM will automatically become disabled, and the operator will derive no economic benefit from it. The lack of such economic benefit will then serve as an incentive for the operator to pay the bank. And, the bank need not take physical possession of the CVM to achieve this result. The bank can wait until it is convenient to take physical possession.

Alternatively, a lessor may lease the operator a CVM in accordance with a contract under which the operator pays the lessor 10% of the sales volume from the CVM every 30 days. The CVM can then be programmed to register the sales volume over each 30 day period and then to shut down automatically unless the operator inputs an authorization code provided by the lessor.

In yet another alternative, let it be assumed that a landlord provides a large space for a bank of CVMs, purchases or leases the CVMs and sites them there, and engages an operator to run the CVMs in accordance with a contract under which the operator must pay the landlord 40% of the sales of the CVMs. After some time, the landlord checks the sales of the CVMs and finds that the operator has been underpaying. The landlord can then input a deauthorization code to the CVMs to shut them down until the operator has settled its accounts with the landlord.

In still another alternative, let it be assumed that a landlord provides a large space filled with CVMs, hires staff to service the machines, and sets different manufacturers in competition with each other to have their goods sold from the CVMs. (In this example, the landlord is also the owner. As stated above, the landlord and owner, just like the owner and manufacturer, the manufacturer and landlord, etc., can be the same or different.) Each manufacturer contracts with the landlord to pay the landlord a rebate based on sales of the manufacturer's goods. If the manufacturer is late in paying the rebate, the landlord can input a deauthorization code to prevent that manufacturer's goods from being sold until the manufacturer has settled accounts with the landlord.

One particularly advantageous embodiment of the invention is-specifically adapted for use in a very common relationship between a manufacturer and an operator. In this common relationship, the manufacturer provides a custom-decorated vending machine to the operator. The vending machine is decorated with e.g. the manufacturer's logo and/or housemark, indicating that COCA-COLA® or PEPSI®) etc. can be purchased from the vending machine. Naturally, when such a relationship exists, the manufacturer and operator enter into contract wherein the operator is obliged to refrain from stocking the vending machine with goods made by a competing manufacturer.

In the CVM disclosed in at least one of the above-referenced patent applications, the CVM can be loaded with different types of goods and the front of the CVM has first and second regions. The manufacturer can supply the CVM with the manufacturer's logo, housemark etc. in the first region, and the operator can provide artwork for other goods in the second region.

With such an arrangement, the operator and manufacturer can contract to provide e.g. that at least 80% (measured by units, sales in dollars, or by whatever criterion the parties negotiate and verified by e.g. a barcode scanner in the CVM) of the goods sold from the CVM will be manufactured by the manufacturer, while allowing the operator the freedom to select the other 20% (for which the operator can put corresponding artwork in the second region). If in actual operation of the CVM the negotiated percentage is not achieved, then the CVM can be programmed to indicate that selected goods are unavailable, preventing them from being sold and thereby increasing the percentage to the negotiated percentage.

In the CVM disclosed in at least one of the above-referenced patent applications, the CVM has a communications port permitting the CVM to be accessed by e.g. the Internet. In an especially advantageous embodiment of the invention, an exclusive contract is established with a data management company that communicates with the CVM through the port and serves as a gateway for other firms that require such communication. The data management company can convey information about e.g. products purchased and dates and times of purchases to firms that can use such information and can also serve as a trusted intermediary so that the CVM is not subjected to conflicting authorization and deauthorization codes from different parties.

In accordance with yet another advantageous aspect of the invention, the third party is paid at least partially by receipt of data. For example, a food manufacturer may produce a new food/snack item and may lack information about consumer acceptance of the item and the times and circumstances under which consumers are likely to purchase it. In such circumstances, the manufacturer may provide the item to the operator at no charge, but rather in accordance with a contract under which the operator must supply information regarding sales of the item at various prices and at various times of day and days of the week. Such information can aid the manufacturer to test-market the new item and to determine consumer acceptance of the item at various price points. If the manufacturer does not receive the information, the manufacturer can either withhold an authorization code or generate a deauthorization code and thereby prevent the operator from deriving a financial benefit by selling the item.

Alternatively, the third party may be paid at least partially by receipt of contract rights. For example, a manufacturer may produce a new food/snack item and may purchase from the operator the right to have the item distributed from all the operator's CVMs, but at various price points so as to conduct a controlled market test.

These different forms of payments need not be mutually exclusive; a third party may for example receive a combination of currency and data.

### DETAILED DESCRIPTION OF PREFERRED EMBODIMENTS

CVMs suitable for the herein-disclosed inventions are disclosed in the above-referenced pending patent applications, the entire disclosures of which are incorporated herein as if fully set forth, including the drawings.

A proper understanding of this invention requires a reconsideration of business arrangements that are traditionally made with respect to vending from machines. In one traditional arrangement, an operator buys or leases a machine, installs it at a landlord's premises, and pays the landlord rent (which may be a commission percentage). In such an arrangement, the landlord must trust the honesty of the operator. While it is possible for the landlord to audit the operator's financial records, the vending business is presently a cash-based business and no party to a vending contract can be sure that all machine receipts are in fact recorded on the operator's books.

In another traditional arrangement, a food or beverage manufacturer engages a vending machine manufacturer to make machines having product-specific graphics (so that a consumer can know e.g. that the machine dispenses PEPSI®) or FRITOS®). This custom-labeled machine is then sold or leased to an operator. In such an arrangement, the food or beverage manufacturer seeks to prevent the operator from selling products other than those for which the custom-labeled machine was originally intended, and most of the time the food manufacturer must simply trust to the honesty of the operator. In some exceptional instances, such machines can read the barcode information on the goods loaded into them, and self-destruct if the goods are not those the machine has been programmed to expect, but this is an extreme and wasteful measure.

These traditional arrangements are necessarily simple and unsophisticated because inter alia it is not feasible for anyone other than the operator to interact with the vending machine.

However, a CVM of the types mentioned above has sufficient intelligence to “know” e.g. the items stored in it, the dates, times, and prices of sales, the dates and times it is serviced and the identity of the person(s) servicing it, etc. (For example, a CVM can use a laser scanner to read the barcode on an item stored in it and this information can be matched with information stored in the CVM.) And, information regarding the contents of the machine and the particulars of sales from the machine can be easily stored in the machine and outputted to a computer (e.g. a laptop or a handheld in the hands of a service person) or sent to a remote computer via a communications port (that connects e.g. to the Internet). This makes it practical for persons other than the operator to have accurate information about the actual operations carried out by the CVM. This in turn makes it practical for parties to make contracts that would have been imprudent using older vending machine technology.

For example, most landlords would have been unwilling to purchase banks of vending machines for use in e.g. company cafeterias. This is because the landlord would likely have to contract with an operator company to stock and service the machines and it would be very difficult for the landlord to be confident that the operator was not skimming cash that properly belonged to the landlord. However, it would be feasible for a landlord to purchase or lease a bank of CVMs and to contract with a third party operator to stock and service them, because the landlord would have recourse to the actual operations carried out by the CVM as a check on the honesty of the operator. In other words, CVMs can practically be owned or leased by persons other than operators, and CVMs make it practical to unbundle functions that formerly would have been carried out by operators alone. Hence, it would be practical (although not necessarily profitable) for an operator to contract with a third party to stock and service CVMs that are remote from the operator's main geographical area.

Hence, the availability of highly sophisticated CVMs makes it possible for parties to consider many different types of contracts that would have been considered imprudent using older vending machines. (As used herein, “contract” is used in its most general sense. The contract need not be written out.) In general, each party to such a contracts will likely fall into one or more of the following categories:

a manufacturer of items dispensed from the CVM;

a person having an ownership interest (e.g. title, lease, security interest, right to operate) in the CVM;

a person having an interest (e.g. title, lease, possessory interest) in real property where the CVM is located;

a person having a legal right to remove money from the CVM;

a person having a legal right to load goods into the CVM; and

a person having a legal right to communicate with the CVM via its communications port.

Although CVMs make it practical for parties to enter into different type of vending contracts, they still require the ability to enforce self-help measures if their contract partner does not adhere to the provisions of the contract. Usually but by no means always, the self-help measure is the entire or partial shutdown of the CVM. In many instances, the CVM will shut down, totally or partially, by the automatic generation of a shut-down signal. For example, the CVM might shut down automatically upon:

a) passage of a predetermined period of time (e.g. a month);

b) movement of the CVM, or excessively frequent movement of the CVM;

c) passage of a predetermined period of time between servicings (to e.g. prevent stale goods in the CVM from being dispensed);

d) excessive sales of a non-branded item in a CVM primarily intended for sales of branded items; or

e) sale of a predetermined sales volume of goods, or of a predetermined sales volume within a predetermined period of time.

To prevent such a shutdown, or to reverse such a shutdown if one has already occurred, an authorization code is input to the CVM. Hence, in accordance with an exemplary preferred embodiment of the invention, a bank may contract with an operator to finance the operator's purchase or lease of a CVM. The CVM is programmed to shut down at noon on the last day of each month unless an authorization code is previously input to the CVM. If the bank receives payment, it generates an authorization code that may be input to the CVM and that will prevent the next scheduled shutdown from taking place. The authorization code may be manually input to the CVM by the operator, or electronically input to the CVM (as via the Internet) if the CVM has a communications port that permits this.

The shutdown of the CVM need not necessarily prevent all operation of the CVM. For example, the CVM disclosed in at least one of the above-referenced patent applications can distinguish between different goods loaded into it. It is possible, for example, to disable the CVM from dispensing only one or two items that have been loaded into it, and to continue to dispense all the others until dispensing of the disabled goods is re-permitted by input of an authorization code.

In accordance with another aspect of the invention, the CVM does not automatically shut down in the absence of a timely input authorization code. Rather, the CVM continues to operate until it is wholly or partially disabled upon receipt of a de-authorization code. This would be preferred when, for example, each party recognizes that the other is a financially responsible entity that can ordinarily be depended upon to meet its financial obligations. In such a context, shutdown should properly be an extraordinary remedy.

Accordingly, in accordance with this aspect of the invention, the third party issues the de-authorization code (or causes it to be issued) and causes it to be input to the CVM, which in turn causes the CVM to at least partially shut down.

In yet another preferred embodiment of the invention, a data management company is engaged to serve as an electronic gateway having the exclusive right to communicate with the CVM through the communications port. This embodiment may be particularly advantageous when an operator enters into a contracts under which a plurality of manufacturers supply items for a single machine. For example, if a CVM is capable of vending 40 items, the data management company may (acting as agent for the operator) contract with five different manufacturers, each supplying 8 items to be sold from the CVM. The data management company would e.g. administer the collection and input of the necessary authorization and deauthorization codes, would prevent the CVM from receiving contradictory codes, and would package and distribute data from the CVM for the benefit of the operator.

Although at least one preferred embodiment of the invention has been described above, this description is not limiting and is only exemplary. The scope of the invention is defined only by the claims, which follow.

1. A method of doing business with a third party wherein the third party is entitled to receive payment based upon actual operations carried out by a computerized vending machine (“CVM”), the CVM having means for disabling itself from dispensing goods unless an authorization code is timely input thereto, comprising the following steps:
contracting with the third party to pay the third party based upon actual operations carried out by the CVM;
generating an authorization code under authority of the third party; and
inputting the authorization code to the CVM.

2. The method of claim 1, wherein the third party is selected from at least one of the following categories:
a seller of goods dispensed from the CVM;
a person having an ownership interest in the CVM;
a person having an interest in real property where the CVM is located;
a person having a legal right to remove money from the CVM; and
a person having a legal right to load goods into the CVM.

3. The method of claim 1, wherein the CVM has a communications port enabling remote electronic communication with the CVM, and wherein the third party is selected from at least one of the following categories:
a manufacturer of items dispensed from the CVM;
a person having an ownership interest in the CVM;
a person having an interest in real property where the CVM is located;
a person having a legal right to remove money from the CVM;
a person having a legal right to load goods into the CVM; and
a person having a legal right to communicate with the CVM via the communications port.

4. The method of claim 1, wherein the payment to the third party includes currency.

5. The method of claim 1, wherein the payment to the third party includes transfer of data to the third party.

6. The method of claim 1, wherein the payment to the third party includes transfer of contract rights to the third party.

7. The method of claim 3, wherein the communication ports is adapted for communication via the Internet.

8. The method of claim 3, wherein the communications port is adapted for communication via a portable computer.

9. The method of claim 8, wherein the portable computer is a handheld computer.

10. A method of doing business with a third party wherein the third party is entitled to receive payment based upon actual operations carried out by a computerized vending machine (“CVM”), the CVM having means for identifying goods loaded therein and means for reversibly disabling itself from dispensing at least some of said goods upon receipt of a deauthorization code, comprising the following steps:
contracting with the third party to pay the third party based upon actual operations carried out by the CVM;
generating a deauthorization code under authority of the third party; and
inputting the deauthorization code to the CVM.

11. The method of claim 10, wherein the deauthorization code reversibly disables the CVM from dispensing particular goods loaded therein while permitting the CVM to continue to dispense other goods loaded therein.

12. A method of doing business with a third party with respect to a computerized vending machine (“CVM”), the CVM having means for disabling itself from dispensing goods unless an authorization code is timely input thereto, comprising the following steps:
contracting with the third party to pay the third party;
generating an authorization code under authority of the third party; and
inputting the authorization code to the CVM.

13. The method of claim 12, wherein the authorization code is input manually.

14. The method of claim 12, wherein the CVM has a communications port and the authorization code is input through the communications port.

15. A method of doing business with a third party with respect to a computerized vending machine (“CVM”), the CVM having means for disabling itself from dispensing goods unless an authorization code is timely input thereto and further having a communications port enabling remote electronic communication with the CVM, comprising the following steps:
contracting with the third party to pay the third party;
contracting with a data management company having the exclusive right to electronically communicate with the CVM through the communications port;
generating an authorization code under authority of the third party; and
providing the authorization code to the data management company for inputting the authorization code to the CVM.

16. A method of doing business with a third party with respect to a computerized vending machine (“CVM”), the CVM having means for reversibly disabling itself from dispensing goods upon receipt of a deauthorization code and further having a communications port enabling remote electronic communication with the CVM, comprising the following steps:
contracting with the third party to pay the third party;
contracting with a data management company having the exclusive right to electronically communicate with the CVM through the communications port; generating a deauthorization code under authority of the third party; and
providing the deauthorization code to the data management company for inputting the deauthorization code to the CVM.

17. A method of operating a computerized vending machine (“CVM”) in conjunction with an interested third party, wherein the third party is entitled to receive at least one of either payment or data based upon actual operations carried out by the CVM, comprising the following steps:
providing a CVM to an operator, the CVM being programmed before said providing to at least partially disabling itself from dispensing goods if an authorization code is not timely input thereto;
making an agreement between the operator and an interested third party to at least one of either make payment or report data to the third party based upon actual operations carried out by the CVM;
generating an authorization code under authority of the third party; and
inputting the authorization code to the CVM.

18. The method of claim 17, wherein the actual operations carried out by the CVM upon which the agreement with the third party is based, comprises at least one of:
a) passage of a predetermined period of time;
b) physical re-location of the CVM;
c) passage of a predetermined period of time between servicings;
d) more than a predetermined amount of sales of a given type of a plurality of types of goods vendible by the CVM;
e) more than a predetermined amount of sales of a non-branded item in a CVM primarily intended for sales of branded items; or
f) sale of a predetermined sales volume of goods, or
g) sale of a predetermined sales volume within a predetermined period of time.

19. The method of claim 17, wherein said inputting of the authorization code to the CVM at least one of prevents or reverses said at least partial disabling of the CVM.

20. A method of operating a computerized vending machine (“CVM”) in conjunction with an interested third party, wherein the third party is entitled to receive at least one of either payment or data based upon actual operations carried out by the CVM, comprising the following steps:
providing a CVM to an operator, the CVM being programmed before said providing to become at least partially disabled from dispensing goods if a de-authorization code is input thereto;
making an agreement between the operator and an interested third party to at least one of either make payment or report data to the third party based upon actual operations carried out by the CVM;
generating a de-authorization code under authority of the third party; and
inputting the de-authorization code to the CVM.

21. The method of claim 20, wherein the actual operations carried out by the CVM upon which the agreement with the third party is based, comprises at least one of:
a) passage of a predetermined period of time;
b) physical re-location of the CVM;
c) passage of a predetermined period of time between servicings;
d) more than a predetermined amount of sales of a given type of a plurality of types of goods vendible by the CVM;
e) more than a predetermined amount of sales of a non-branded item in a CVM primarily intended for sales of branded items; or
f) sale of a predetermined sales volume of goods, or
g) sale of a predetermined sales volume within a predetermined period of time.

22. A method of operating a computerized vending machine (“CVM”) having a display portion which displays a plurality of goods of several types vendible by the CVM, comprising the following steps:
providing a CVM to an operator, the CVM being programmed before said providing to accumulate sales data relating to each of the plurality of goods vendible by the CVM; and
making an agreement between the operator and an interested third party to operate the CVM to vend the goods according to predetermined rules;
wherein the CVM is also preprogrammed before said providing to at least partially disable vending of goods based on an internal analysis of the sales data which indicates that vending of goods will not conform to the predetermined rules.

23. The method of claim 22,
wherein the agreement between the operator and the interested third party includes a rule to operate the CVM so that a predetermined percentage of the goods vended by the CVM are of a certain type; and
wherein the CVM preprogramming causes said disabling based on an internal analysis of the sales data which indicates that vending of goods of the certain type will not comprise a predetermined minimum percentage of the total goods vended by the CVM.

24. The method of claim 23,
wherein the CVM is preprogrammed to cease the at least partial disabling of the vending of goods, based on an internal analysis of the sales data which indicates that vending of goods of the certain type will again comprise at least the predetermined minimum percentage of the total goods vended by the CVM.

25. The method of claim 23, wherein
one type of the goods are supplied by a given manufacturer and the remaining types of goods are supplied by other manufacturers, and
said agreement with the interested third party includes agreeing that the goods supplied by the given manufacturer will comprise a predetermined minimum percentage of the total goods vended by the CVM.

26. A method of operating a computerized vending machine (“CVM”) in conjunction with an interested third party, wherein the third party is entitled to receive at least one of either payment or data based upon actual operations carried out by the CVM, comprising the following steps:
providing a CVM to an operator, the CVM being programmed before said providing to:
accumulate sales data relating to the vending of at least some of the plurality of goods vendible by the CVM;
become at least partially disabled from dispensing goods if a de-authorization code is input thereto;
making an agreement between the operator and an interested third party to report at least some of the accumulated data to the third party;
generating a de-authorization code under authority of the third party; and
inputting the de-authorization code to the CVM.
